(19) United States
(12) Patent Application Publication
(10) Pub. No.: US 2004/0006163 A1
(43) Pub. Date: Jan. 8, 2004

(54) Rubber compositions having improved scorch safety

(75) Inventors: Sung W. Hong, Cheshire, CT (US); Peter K. Greene, Goshen, CT (US)

Correspondence Address: Kenneth D. Tremain, Crompton Corporation, Benson Road, Middlebury, CT, 06749, US

(73) Assignee: UNIROYAL CHEMICAL COMPANY

(21) Appl. No.: 10/184,663

(22) Filed: Jun. 27, 2002

(51) Int. Cl. C08K 5/38

(52) U.S. Cl. 524/201; 524/392; 524/495; 152/209.1

(57) ABSTRACT

A rubber composition is disclosed wherein the rubber composition contains at least (a) a rubber component; (b) a carbon black filler and (c) an effective amount of a thiuram disulfide accelerator of the general formula

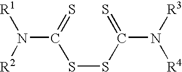

wherein R¹, R², R³ and R⁴ each are the same or different and are hydrocarbons containing from about 8 to about 18 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms. The compositions may also include suitable amounts of other ingredients such as antiozonants, antioxidants, etc.

### BACKGROUND OF THE INVENTION

1. Technical Field

This invention relates generally to rubber compositions and methods for improving scorch safety of a rubber composition. The rubber compositions are particularly useful for tire treads and other tire components in a vehicle, e.g., bicycle, motor bike, passenger automobiles and trucks.

2. Description of the Related Art

The external components of modem tires such as, for example, tire treads, sidewall and linear compounds, must meet performance standards which require a broad range of desirable properties. Generally, three types of performance standards are important in tread compounds. They include good wear resistance, good traction and low rolling resistance. Major tire manufacturers have developed tread compounds which provide lower rolling resistance for improved fuel economy and better skid/traction for a safer ride. Thus, rubber compositions suitable for, e.g., tire treads, should exhibit not only desirable strength and elongation, particularly at high temperatures, but also good cracking resistance, good abrasion resistance, desirable skid resistance, low tangent delta values at 60° C. and low frequencies for desirable rolling resistance of the resulting treads. Additionally, a high complex dynamic modulus is necessary for maneuverability and steering control. A high Mooney Scorch value is further needed for processing safety.

In addition to the external tire components, rubber compositions suitable for internal components of a tire such as, for example, carcass, belt, and apex, are desirably cured faster to match the cure rate of the external components.

In general, rubber compositions in which a carbon black filler is compounded into a rubber component, e.g., natural rubber, polybutadiene, polyisoprene or styrene-butadiene copolymer rubber, are widely used as rubber materials for such articles as, for example, tires. However, the need for improved productivity requires an improved cure rate of the rubber composition.

In order to increase the cure rate, secondary accelerators such as, for example, low molecular weight thiuram disulfides, e.g., tetramethyl thiuram monosulfide, tetramethyl thiuram disulfide, tetraethyl thiuram disulfide or tetrabutyl thiuram disulfide, and diphenyl guanidine (DPG), have been added to the rubber compositions. However, problems are associated with the use of these secondary accelerators. For example, low molecular weight thiuram disulfides are known to generate nitrosamines resulting in worldwide environmental concerns. Also, the use of low molecular weight thiurams and/or DPG result in the rubber composition having a lower Mooney Scorch value during its manufacture thereby resulting in decreased processing time. Problems associated with a decreased processing time include, for example, precured compounds and rough surfaces on extruded parts. Additionally, DPG is typically employed in high amounts which result in the rubber compositions being more expensive to manufacture since more material must be used.

It would be desirable to provide a rubber composition which employs an accelerator that does not generate environmentally undesirable nitrosamine compounds. It would also be desirable to provide a rubber composition which has a decreased cure time and higher scorch safety without sacrificing other physical properties, e.g., tangent delta value. This will allow for better processing of the rubber composition during its manufacture.

### SUMMARY OF THE INVENTION

In accordance with the present invention, a rubber composition is provided which comprises (a) a rubber component; (b) a carbon black filler and (c) an effective amount of a thiuram disulfide accelerator of the general formula

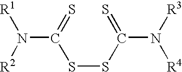

wherein R¹, R², R³ and R⁴ each are the same or different and are hydrocarbons containing from about 8 to about 18 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms.

Further in accordance with the present invention, a method for improving scorch safety of a rubber composition is provided which comprises the step of forming a rubber composition comprising (a) a rubber component; (b) a carbon black filler and (c) an effective amount of a thiuram disulfide accelerator of the general formula

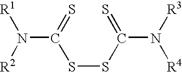

wherein R¹, R², R³ and R⁴ each are the same or different and are hydrocarbons containing from about 8 to about 18 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms.

The thiuram disulfide accelerators of the present invention, in addition to eliminating or substantially eliminating the formation of nitrosamines, have excellent curing characteristics such as cure rate and scorch safety without sacrificing physical properties such as, for example, tangent delta value and stress-strain properties. In this manner, it has unexpectedly been discovered that an accelerator system having a desirable balance of low nitrosamine formation, excellent curing characteristics and scorch safety properties can be achieved.

The term “phr” is used herein as its art-recognized sense, i.e., as referring to parts of a respective material per one hundred (100) parts by weight of rubber.

### DESCRIPTION OF THE PREFERRED EMBODIMENTS

In accordance with the present disclosure, the rubber components for use in the rubber compositions of the present invention are based on highly unsaturated rubbers such as, for example, natural or synthetic rubbers. Representative of the highly unsaturated polymers that can be employed in the practice of this invention are diene rubbers. Such rubbers will ordinarily possess an iodine number of between about 20 to about 450, although highly unsaturated rubbers having a higher or a lower (e.g., of 50-100) iodine number can also be employed. Illustrative of the diene rubbers that can be utilized are polymers based on conjugated dienes such as, for example, 1,3-butadiene; 2-methyl-1,3-butadiene; 1,3-pentadiene; 2,3-dimethyl-1,3-butadiene; and the like, as well as copolymers of such conjugated dienes with monomers such as, for example, styrene, alpha-methylstyrene, acetylene, e.g., vinyl acetylene, acrylonitrile, methacrylonitrile, methyl acrylate, ethyl acrylate, methyl methacrylate, ethyl methacrylate, vinyl acetate, and the like. Preferred highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, and poly (acrylonitrile-butadiene). Moreover, mixtures of two or more highly unsaturated rubbers with elastomers having lesser unsaturation such as EPDM, EPR, butyl or halogenated butyl rubbers are also within the contemplation of the invention.

Suitable carbon black fillers for use herein include any of the commonly available, commercially-produced carbon blacks known to one skilled in the art. Generally, those having a surface area (EMSA) of at least about 5 m²/g, preferably at least about 35 m²/g and most preferably at least about 200 m²/g are preferred. Surface area values used in this application are those determined by ASTM test D-3765 using the cetyltrimethyl-ammonium bromide (CTAB) technique. Among the useful carbon blacks are furnace black, channel blacks and lamp blacks. More specifically, examples of the carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which may be utilized include acetylene blacks and thermal blacks. Mixtures of two or more of the above blacks can be used in preparing the rubber compositions of the invention. Typical values for surface areas of usable carbon blacks are summarized in the following Table I.

TABLE I
Carbon Blacks

| ASTM | Surface Area |
|---|---|
| Designation | (m²/g) |
| (D-1765-82a) | (D-3765) |
| N-110 | 126 |
| N-234 | 120 |
| N-220 | 111 |
| N-339 | 95 |
| N-330 | 83 |
| N-550 | 42 |
| N-660 | 35 |

The carbon blacks utilized in the invention may be in pelletized form or an unpelletized flocculant mass. Preferably, for ease of handling, pelletized carbon black is preferred. The carbon blacks are ordinarily incorporated into the rubber composition in amounts ranging from about 10 to about 100 phr, preferably from about 30 to about 90 phr and most preferably from about 45 to about 85 phr.

The thiuram disulfide accelerators for use in the rubber compositions of this invention as an accelerator advantageously provide a rubber composition possessing an increased scorch safety. It is also advantageous to employ the thiuram disulfide accelerators herein as the thiuram disulfides substantially eliminate the formation of nitrosamines during the production of the rubber composition.

As such, the thiuram disulfide accelerators for use herein are those of the general formula

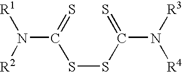

wherein R¹, R², R³ and R⁴ each are the same or different and are hydrocarbons containing from about 8 to about 18 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms. A particularly preferred thiuram disulfide for use herein is wherein R¹, R², R³ and R⁴ each possess a linear or branched alkyl group having between 12 and 14 carbon atoms. Generally, the thiuram disulfide is advantageously present in the rubber composition of this invention in an amount effective to increase the scorch safety of the composition while providing a decreased cure time. The amount of the thiuram disulfide will ordinarily range from about 0.05 to about 1.0 phr, preferably from about 0.10 to about 0.8 phr and most preferably from about 0.20 to about 0.60 phr.

The foregoing thiuram disulfides can be, for example, premixed, or blended, with the sulfur and other curatives to the rubber mix during the finish mixing stage.

The rubber compositions of this invention can be formulated in any conventional manner. Additionally, at least one other common additive can be added to the rubber compositions of this invention, if desired or necessary, in a suitable amount. Suitable common additives for use herein include fillers other than carbon black, vulcanizing agents, activators, retarders, antioxidants, plasticizing oils and softeners, reinforcing pigments, antiozonants, waxes, tackifier resins, coupling agents and the like and combinations thereof.

Examples of other fillers that can be incorporated into the rubber compositions of the present invention with the carbon black fillers include, but are not limited to, general inorganic fillers, e.g., calcium carbonate, clay, talc, diatomaceous earth, mica, alumina, aluminum sulfate, barium sulfate or calcium sulfate, silica, mixtures thereof and the like. The silica filler may be of any type that is known to be useful in connection with the reinforcing of rubber compositions. Representative of suitable silica fillers include, but are not limited to, silica, precipitated silica, amorphous silica, vitreous silica, fumed silica, fused silica, synthetic silicates such as aluminum silicates, alkaline earth metal silicates such as magnesium silicate and calcium silicate, natural silicates such as kaolin and other naturally occurring silicas and the like. Also useful are highly dispersed silicas having, e.g., BET surfaces of from about 5 to about 1000 m²/g and preferably from about 20 to about 400 m²/g and primary particle diameters of from about 5 to about 500 nm and preferably from about 10 to about 400 nm. These highly dispersed silicas can be prepared by, for example, precipitation of solutions of silicates or by flame hydrolysis of silicon halides. The silicas can also be present in the form of mixed oxides with other metal oxides such as, for example, Al, Mg, Ca, Ba, Zn, Zr, Ti oxides and the like. Commercially available silica fillers known to one skilled in the art include, e.g., those available from such sources as Cabot Corporation under the Cab-O-Sil® tradename; PPG Industries under the Hi-Sil and Ceptane tradenames; Rhodia under the Zeosil tradename and Degussa AG under the Ultrasil and Coupsil tradenames.

When employing a silica filler in the rubber composition of the present invention, it is advantageous to also employ a coupling agent. Such coupling agents, for example, may be premixed, or pre-reacted, with the silica particles or added to the rubber mix during the rubber/silica processing, or mixing, stage. If the coupling agent and silica are added separately to the rubber mix during the rubber/silica mixing, or processing stage, it is considered that the coupling agent then combines in situ with the silica.

In particular, such coupling agents are generally composed of a silane which has a constituent component, or moiety, (the silane portion) capable of reacting with the silica surface and, also, a constituent component, or moiety, capable of reacting with the rubber, e.g., a sulfur vulcanizable rubber which contains carbon-to-carbon double bonds, or unsaturation. In this manner, then, the coupling agent acts as a connecting bridge between the silica and the rubber thereby enhancing the rubber reinforcement aspect of the silica.

The silane component of the coupling agent apparently forms a bond to the silica surface, possibly through hydrolysis, and the rubber reactive component of the coupling agent combines with the rubber itself. Generally, the rubber reactive component of the coupling agent is temperature sensitive and tends to combine with the rubber during the final and higher temperature sulfur vulcanization stage, i.e., subsequent to the rubber/silica/coupling mixing stage and after the silane group of the coupling agent has combined with the silica. However, partly because of typical temperature sensitivity of the coupling agent, some degree of combination, or bonding, may occur between the rubber-reactive component of the coupling agent and the rubber during an initial rubber/silica/coupling agent mixing stage and prior to a subsequent vulcanization stage.

Suitable rubber-reactive group components of the coupling agent include, but are not limited to, one or more of groups such as mercapto, amino, vinyl, epoxy, and sulfur groups. Preferably the rubber-reactive group components of the coupling agent is a sulfur or mercapto moiety with a sulfur group being most preferable.

Examples of a coupling agent for use herein are vinyltrichlorosilane, vinyltrimethoxysilane, vinyltriethoxysilane, vinyltris(β-methoxyethoxy) silane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, -β(aminoethyl)-γ-aminopropylmethyldimethoxysilane, N-β-(aminoethyl)γ-aminopropyltrimethoxysilane, N-β(aminoethyl)γ-aminopropyltriethoxysilane, γ-aminopropyltrimethoxysilane, γ-aminopropyltriethoxysilane, -phenyl-γ-aminopropyltrimethoxysilane, γ-chloropropyltrimethoxysilane, γ-mercaptopropyltrimethoxysilane and combinations thereof. Examples of sulfur-containing organosilicon compounds which may be used herein include, but are not limited to, 3,3′-bis(trimethoxysilylpropyl) disulfide, 3,3′-bis(triethoxysilylpropyl) disulfide, 3,3-bis(triethoxysilylpropyl) tetrasulfide, 3,3′-bis(triethoxysilylpropyl) octasulfide, 3,3′-bis(trimethoxysilylpropyl) tetrasulfide, 2,2′-bis(triethoxysilylethyl) tetrasulfide, 3,3′-bis(trimethoxysilylpropyl) triasulfide, 3,3′-bis(triethoxysilylpropyl) triasulfide, 3,3′-bis(tributoxysilylpropyl) disulfide, 3,3′-bis(trimethoxysilylpropyl) hexasufide, 3,3′-bis(trimethoxysilylpropyl) octasulfide, 3,3′-bis(trioctoxysilylpropyl) tetrasulfide, 3,3′-bis(trihexoxysilylpropyl) disulfide, 3,3′-bis(tri-2″-ethylhexoxysilylpropyl) trisulfide, 3,3′-bis(triisooctoxysilyipropyl) tetrasulfide, 3,3′-bis(tri-t-butoxysilyl-propyl) disulfide, 2,2′-bis(methoxydiethoxysilylethyl) tetrasulfide, 2,2′-bis(tripropoxysilylethyl) pentasulfide, 3,3′-bis(tricyclohexoxysilylpropyl) tetrasulfide, 3,3′-bis(tricyclopentoxysilylpropyl) trisulfide, 2,2′-bis(tri-2″-methyl-cyclohexoxysilylethyl) tetrasulfide, bis(trimethoxysilylmethyl) tetrasulfide, 3-methoxy ethoxy propoxysilyl 3′-diethoxybutoxy-silylpropyltetrasulfide, 2,2′-bis(dimethyl methoxysilylethyl) disulfide, 2,2′-bis(dimethyl sec.butoxysilylethyl) trisulfide, 3,3′-bis(methylbutylethoxysilylpropyl) tetrasulfide, 3,3′-bis(di t-butylmethoxysilylpropyl) tetrasulfide, 2,2′-bis(phenylmethylmethoxysilylethyl) trisulfide, 3,3′-bis(diphenylisopropoxysilylpropyl) tetrasulfide, 3,3′-bis(diphenyl cyclohexoxysilylpropyl) disulfide, 3,3′-bis(dimethylethylmercaptosilylpropyl) tetrasulfide, 2,2′-bis(methyldimethoxysilylethyl) trisulfide, 2,2′-bis(methyl ethoxypropoxysilylethyl) tetrasulfide, 3,3′-bis(diethylmethoxysilylpropyl) tetrasulfide, 3,3′-bis(ethyl di-sec. butoxysilylpropyl) disulfide, 3,3′-bis(propyldiethoxysilylpropyl) disulfide, 3,3′-bis(butyl dimethoxysilylpropyl) trisulfide, 3,3′-bis(phenyl dimethoxysilylpropyl) tetrasulfide, 3-phenylethoxy-butoxysilyl 3′-trimethoxysilyipropyl tetrasulfide, 4,4′-bis(trimethoxysilylbutyl) tetrasulfide, 6,6′-bis(triethoxysilylhexyl) tetrasulfide, 12,12′-bis(triisopropoxy-silyldodecyl) disulfide, 18,18′-bis(trimethoxysilyloctadecyl) tetrasulfide, 18,18′-bis(tripropoxysilyloctadecenyl) tetrasulfide, 4,4′-bis(trimethoxy-silylbutene-2-yl) tetrasulfide, 4,4′-bis(trimethoxysilylcyclohexylene) tetrasulfide, 5,5′-bis(dimethoxymethylsilylpentyl) trisulfide, 3,3′-bis(trimethoxy-silyl-2-methylpropyl) tetrasulfide, 3,3′-bis(dimethoxyphenylsilyl-2-methylpropyl) disulfide and the like.

The rubber compositions of this invention are particularly useful when manufactured into articles such as, for example, tires, motor mounts, rubber bushings, power belts, printing rolls, rubber shoe heels and soles, rubber floor tiles, caster wheels, elastomer seals and gaskets, conveyor belt covers, hard rubber battery cases, automobile floor mats, mud flap for trucks, ball mill liners, windshield wiper blades and the like. Preferably, the rubber compositions of this invention are advantageously used in a tire as a component of any or all of the thermosetting rubber-containing portions of the tire. These include the tread, sidewall, and carcass portions intended for, but not exclusive to, a truck tire, passenger tire, off-road vehicle tire, vehicle tire, high speed tire, bicycle tire and motorcycle tire that also contain many different reinforcing layers therein. Such rubber or tire tread compositions in accordance with the invention may be used for the manufacture of tires or for the re-capping of worn tires.

### EXAMPLES

The following non-limiting examples are intended to further illustrate the present invention and are not intended to limit the scope of the invention in any manner.

### Comparative Examples A-C and Example 1

Employing the ingredients indicated in Tables II and III (which are listed in parts per hundred of rubber by weight), several rubber compositions were compounded in the following manner: the ingredients indicated in Table II were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table III. The second pass is shorter and discharge temperatures generally run between 93-105° C.

TABLE II
PHASE I

| Comp. Ex/Ex. | A | B | C | 1 |
|---|---|---|---|---|
| SIR 10¹ | 100.00 | 100.00 | 100.00 | 100.00 |
| N220² | 50.00 | 50.00 | 50.00 | 50.00 |
| AROMATIC OIL | 1.00 | 1.00 | 1.00 | 1.00 |
| ZINC OXIDE | 3.00 | 3.00 | 3.00 | 3.00 |
| STEARIC ACID | 1.50 | 1.50 | 1.50 | 1.50 |
| MB-1: TOTAL | 155.50 | 155.50 | 155.50 | 155.50 |

¹Standard Indonesian Natural Rubber, Grade 10.
²Carbon black available from Cabot Corporation.

TABLE III
PHASE II

| Comp. Ex./Ex. | A | B | C | 1 |
|---|---|---|---|---|
| MB-1³ | 155.50 | 155.50 | 155.50 | 155.50 |
| Delac NS⁴ | 1.00 | 1.00 | 1.00 | 1.00 |
| SULFUR 21-10⁵ | 1.50 | 1.50 | 1.50 | 1.50 |
| TUEX⁶ | 0.00 | 0.25 | 0.00 | 0.00 |
| BENZYL TUEX⁷ | 0.00 | 0.00 | 0.25 | 0.00 |
| ROYALAC 150⁸ | 0.00 | 0.00 | 0.00 | 0.25 |
| TOTAL | 158.00 | 158.25 | 158.25 | 158.25 |

³MB-1 is the batch provided as set forth in Table II.
⁴N-t-butyl-2-benzothiazole sulfenamide available from Uniroyal Chemical Company.
⁵Sulfur available from R. E. Carroll Co.
⁶Tetramethyl thiuram disulfide available from Uniroyal Chemical Company.
⁷Tetrabenzyl thiuram disulfide available from Uniroyal Chemical Company.
⁸Tetraalkyl thiuram disulfide available from Uniroyal Chemical Company.

Results

The compounded stocks prepared above were then sheeted out and cut for cure. The samples were cured for the times and at the temperatures indicated in Table IV and their physical properties evaluated. The results are summarized in Table IV below. Note that in Table IV, cure characteristics were determined using a Monsanto rheometer ODR 2000 (1° ARC, 100 cpm): MH is the maximum torque and ML is the minimum torque. Scorch safety (tₛ2) is the time to 2 units above minimum torque (ML), cure time (t₅₀) is the time to 50% of delta torque above minimum and cure time (t₉₀) is the time to 90% of delta torque above minimum. Example 1 illustrates a rubber composition within the scope of this invention. Comparative Examples A-C illustrate a rubber composition outside the scope of this invention.

### Cured Physical Properties

TABLE IV

| Comp. Ex./Ex. | A | B | C | 1 |
|---|---|---|---|---|
| Cured Characteristics obtained | | | | |
| at 160° C. | | | | |
| ML (lb-in.) | 2.28 | 2.33 | 2.24 | 2.31 |
| MH (lb-in.) | 23.36 | 27.84 | 26.18 | 24.47 |
| Scorch safety t₅2 (min) | 3.15 | 2.07 | 2.51 | 2.81 |
| Cure time t₅₀ (min) | 4.05 | 2.52 | 2.96 | 3.35 |
| Cure time t₉₀ (min) | 5.77 | 3.67 | 4.16 | 4.54 |
| Mooney Scorch (MS at 135° C.) | | | | |
| 3 Pt. Rise Time (min) | 17 | 12 | 16 | 16 |
| Stress/Strain | | | | |
| Cure time at 160° C. (min) | 12.50 | 10.00 | 10.00 | 10.00 |
| Tensile Strength (Mpa) | 27.00 | 27.00 | 26.20 | 27.90 |
| Elongation, % at Break | 540.00 | 470.00 | 480.00 | 540.00 |
| 100% Modulus (Mpa) | 2.50 | 2.60 | 2.70 | 2.40 |
| 300% Modulus (Mpa) | 12.40 | 14.40 | 14.50 | 12.50 |
| Hardness, Shore A. | 65.00 | 62.00 | 65.00 | 64.00 |

It can be seen from the above data that the examples containing a thiuram disulfide within the scope of the present invention (Example 1) provides improved performance when compared to the examples containing no thiuram disulfide accelerator (Comparative Example A) or a thiuram disulfide outside the scope of the invention (Comparative Examples B and C). The cure time for the rubber composition of Example 1 was faster than that of Comparative Example A which contains no thiuram disulfide accelerator while providing substantially equivalent scorch safety which is desirable in rubber compositions.

Additionally, when comparing the scorch safety for the rubber composition of Example 1 with the rubber compositions of Comparative Examples B and C which contain a thiuram disulfide outside the scope of the present invention, it can be seen that the scorch safety was significantly improved while also having relatively equivalent cure times which is entirely unexpected.

### Comparative Examples D-G and Example 2

Employing the ingredients indicated in Tables V and VI (which are listed in parts per hundred of rubber by weight), several rubber compositions were compounded in the following manner: the ingredients indicated in Table V were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table VI. The second pass is shorter and discharge temperatures generally run between 93-105° C.

TABLE V
PHASE I

| Comp. Ex./Ex. | D | E | F | G | 2 |
|---|---|---|---|---|---|
| SOLFLEX 1216⁹ | 75.00 | 75.00 | 75.00 | 75.00 | 75.00 |
| BUDENE 1207¹⁰ | 25.00 | 25.00 | 25.00 | 25.00 | 25.00 |
| N-234 CARBON | 72.00 | 72.00 | 72.00 | 72.00 | 72.00 |
| BLACK¹¹ | | | | | |
| AROMATIC OIL | 32.50 | 32.50 | 32.50 | 32.50 | 32.50 |
| ZINC OXIDE | 2.50 | 2.50 | 2.50 | 2.50 | 2.50 |
| STEARIC ACID | 1.00 | 1.00 | 1.00 | 1.00 | 1.00 |
| FLEXZONE 7P¹² | 2.00 | 2.00 | 2.00 | 2.00 | 2.00 |
| SUNPROOF | 1.50 | 1.50 | 1.50 | 1.50 | 1.50 |
| IMPROVED WAX | | | | | |
| MB-2: TOTAL | 211.50 | 211.50 | 211.50 | 211.50 | 211.50 |

⁹Solution styrene-butadiene rubber low styrene and medium vinyl content available from Goodyear.
¹⁰Polybutadiene rubber available from Goodyear.
¹¹High surface area carbon black available from Cabot Corp.
¹²Paraphenylene diamine available from Uniroyal Chemical Company.

TABLE VI
PHASE II

| Comp. Ex./Ex | D | E | F | G | 2 |
|---|---|---|---|---|---|
| MB-2¹³ | 211.50 | 211.50 | 211.50 | 211.50 | 211.50 |
| Delac NS | 1.50 | 1.50 | 1.50 | 1.50 | 1.50 |
| SULFUR 21-10 | 2.00 | 2.00 | 2.00 | 2.00 | 2.00 |
| MONEX¹⁴ | 0.00 | 0.25 | 0.00 | 0.00 | 0.00 |
| TUEX | 0.00 | 0.00 | 0.25 | 0.00 | 0.00 |
| ROYALAC 150 | 0.00 | 0.00 | 0.00 | 0.00 | 0.25 |
| BENZYL TUEX | 0.00 | 0.00 | 0.00 | 0.25 | 0.00 |
| TOTAL | 215.00 | 215.25 | 215.25 | 215.25 | 215.25 |

¹³MB-2 is the batch provided as set forth in Table V.
¹⁴Tetramethyl thiuram monsulfide.

Results

The compounded stocks prepared above were then sheeted out and cut for cure. The samples were cured for the times and at the temperatures indicated in Table VII and their physical properties evaluated as in Examples 1-4 above. The results are summarized in Table VII below. Example 2 illustrates a rubber composition within the scope of this invention. Comparative Examples D-G illustrate a rubber composition outside the scope of this invention.

### Cured Physical Properties

TABLE VII

| Comp Ex/Ex. | D | B | F | G | 2 |
|---|---|---|---|---|---|
| Cured Characteristics | | | | | |
| obtained at 160° C. | | | | | |
| ML (lb-in.) | 4.30 | 4.24 | 4.30 | 4.31 | 4.28 |
| MH (lb-in.) | 25.15 | 26.29 | 25.89 | 25.41 | 24.33 |
| Scorch safety t₅2 (min) | 4.65 | 4.32 | 3.50 | 4.28 | 4.72 |
| Cure time t₅₀ (min) | 6.78 | 5.45 | 4.63 | 5.66 | 6.36 |
| Cure time t₉₀ (min) | 10.00 | 6.94 | 6.13 | 7.59 | 8.86 |
| Mooney Scorch (MS at | | | | | |
| 135° C.) | | | | | |
| 3 Pt. Rise Time (min) | 16.00 | 15.00 | 12.00 | 16.00 | 17.00 |
| Mooney Viscosity | 85.00 | 84.00 | 85.00 | 84.00 | 84.00 |
| (Viscosity (ML₁₊₄ at | | | | | |
| 100° C.) | | | | | |
| Stress/Strain | | | | | |
| Cured time at 160° C. | 15.00 | 12.00 | 12.00 | 12.00 | 12.00 |
| (min) | | | | | |
| Tensile Strength (Mpa) | 20.10 | 18.70 | 18.50 | 18.00 | 20.90 |
| Elongation, % at Break | 480.00 | 430.00 | 410.00 | 410.00 | 480.00 |
| 100% Modulus (Mpa) | 2.60 | 3.10 | 3.00 | 3.00 | 2.70 |
| 300% Modulus (Mpa) | 11.20 | 12.60 | 12.90 | 12.60 | 11.60 |
| Hardness, Shore A. | 63.00 | 65.00 | 64.00 | 62.00 | 63.00 |
| Monsanto Flex to | | | | | |
| Fatigue - #14 cam, | | | | | |
| Kc to Failure | | | | | |
| Unaged | 317.10 | 176.60 | 199.80 | 442.60 | 236.70 |
| aged 2 weeks @ 70° C. | 40.20 | 63.90 | 54.40 | 60.70 | 70.50 |
| % Retension | 12.7% | 36.2% | 27.2% | 13.7% | 29.8% |

It can be seen from the above data that the examples containing a thiuram disulfide within the scope of the present invention (Example 2) provides improved performance when compared to the examples containing no thiuram disulide accelerator (Comparative Example D) or a thiuram accelerator outside the scope of the invention (Comparative Examples E-G). The cure rates were comparable or faster for Example 2 than that of Comparative Examples D-G while the scorch safety of the rubber compositions of the present invention was improved resulting in an economical cost advantage being realized

Although the invention has been described in its preferred form with a certain degree of particularity, obviously many changes and variations are possible therein and will be apparent to those skilled in the art after reading the foregoing description. It is therefore to be understood that the present invention may be presented otherwise than as specifically described herein without departing from the spirit and scope thereof.

What is claimed is:

1. A rubber composition comprising (a) a rubber component; (b) a carbon black filler and (c) an effective amount of a thiuram disulfide accelerator of the general formula 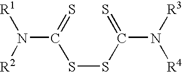
wherein R¹, R², R³ and R⁴ each are the same or different and are hydrocarbons containing from about 8 to about 18 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms.

2. The rubber composition of claim 1 wherein the rubber component is selected from the group consisting of natural rubber, homopolymers of conjugated diolefins, copolymers of conjugated diolefins and ethylenically unsaturated monomers and mixtures thereof.

3. The rubber composition of claim 1 wherein the rubber component is selected from the group consisting of natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, poly (acrylonitrile-butadiene) and ethylene-propylene-diene terpolymer.

4. The rubber composition of claim 1 wherein the carbon black filler is selected from the group consisting of furnace black, acetylene black, thermal black, channel black and mixtures thereof.

5. The rubber composition of claim 1 wherein R¹, R², R³ and R⁴ of the thiuram disulfide each are the same or different and are hydrocarbons containing from about 12 to about 14 carbon atoms.

6. The rubber composition of claim 1 wherein the effective amount of the thiuram disulfide accelerator is about 0.05 to about 1.0 phr.

7. The rubber composition of claim 5 wherein the effective amount of the thiuram disulfide accelerator is about 0.05 to about 1.0 phr.

8. The rubber composition of claim 1 further comprising at least one other additive selected from the group consisting of vulcanizing agents, activators, fillers other than carbon black, retarders, antioxidants, plasticizing oils, and softeners, reinforcing pigments, antiozonants, waxes, tackifier resins and combinations thereof.

9. The rubber composition of claim 1 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.

10. The rubber composition of claim 5 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.

11. A method for improving scorch safety of a rubber composition which comprises the step of forming a rubber composition comprising (a) a rubber component; (b) a carbon black filler and (c) an effective amount of a thiuram disulfide accelerator of the general formula 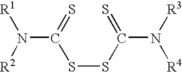
wherein R¹, R², R³ and R⁴ each are the same or different and are hydrocarbons containing from about 8 to about 18 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms.

12. The method of claim 11 wherein the rubber component is selected from the group consisting of natural rubber, homopolymers of conjugated diolefins, copolymers of conjugated diolefins and ethylenically unsaturated monomers and mixtures thereof.

13. The method of claim 11 wherein the carbon black filler is selected from the group consisting of furnace black, acetylene black, thermal black, channel black and mixtures thereof.

14. The method of claim 11 wherein R¹, R², R³ and R⁴ of the thiuram disulfide each are the same or different and are hydrocarbons containing from about 12 to about 14 carbon atoms.

15. The method of claim 11 wherein the effective amount of the thiuram disulfide accelerator is about 0.05 to about 1.0 phr.

16. The method of claim 14 wherein the effective amount of the thiuram disulfide accelerator is about 0.05 to about 1.0 phr.

17. An article of manufacture comprising a rubber composition comprising (a) a rubber component; (b) a carbon black filler and (c) an effective amount of a thiuram disulfide accelerator of the general formula 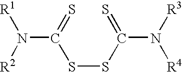
wherein R¹, R², R³ and R⁴ each are the same or different and are hydrocarbons containing from about 8 to about 18 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms.

18. The article of manufacture of claim 17 wherein R¹, R², R³ and R⁴ of the thiuram disulfide each are the same or different and are hydrocarbons containing from about 12 to about 14 carbon atoms.

19. The article of manufacture of claim 17 wherein the effective amount of the thiuram disulfide accelerator is about 0.05 to about 1.0 phr.

20. The article of manufacture of claim 17 wherein the effective amount of the thiuram disulfide accelerator is about 0.05 to about 1.0 phr.

21. The article of manufacture of claim 17 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.
